(19) United States
(12) Patent Application Publication
(10) Pub. No.: US 2016/0121184 A1
(43) Pub. Date: May 5, 2016

(54) GUIDED LIGHT SYSTEM FOR ATHLETIC TRAINING AND USE

(71) Applicant: NEW VISION RENEWABLE ENERGY, Philippi, WV (US)

(72) Inventors: Ruston SEAMAN, Philippi, WV (US); John PRUSA, Philippi, WV (US)

(73) Assignee: NEW VISION RENEWABLE ENERGY, Philippi, WV (US)

(21) Appl. No.: 14/932,446

(22) Filed: Nov. 4, 2015

Related U.S. Application Data
(60) Provisional application No. 62/075,196, filed on Nov. 4, 2014.

(51) Int. Cl. A63B 63/08; A63B 24/00; A63B 69/00; F21V 21/088; F21V 23/00

(52) U.S. Cl. CPC A63B 63/083; F21V 21/088; F21V 23/003; A63B 69/0071; A63B 24/0021; A63B 2024/0025; A63B 2024/0028

(57) ABSTRACT

A system for training an athlete by using a light array to aid in focusing the athlete's eyes on a target is provided. The system includes a light assembly positioned proximal to a basketball rim. The system further includes a tracking module configured for determining a shot position relative to the basketball rim, and a control module in communication with the tracking module and configured for illuminating a portion of the light assembly that faces the shot position.

### CROSS REFERENCE TO RELATED APPLICATIONS

This non-provisional application claims the benefit under 35 U.S.C. §119(e) to U.S. Provisional Application No. 62/075,196, filed on Nov. 4, 2014, all of which are hereby expressly incorporated by reference into the present application.

### BACKGROUND

This application relates to the game of basketball, and more specifically to a backboard or support structure therefor.

An athlete in any sport trains to improve his or her athletic skills. In sports where a target is involved, training involves repetitive attempts to reach the target with accuracy and precision using the sport's projectile. For example, a basketball athlete trains to improve the accuracy and precision of shots taken from various positions on a court, particularly from the free throw line, in order to reach the target, a basketball rim, with a basketball as frequently as possible.

Typically, in basketball and many other sports, shot training involves repeated shot attempts in order to develop the athlete's muscle memory and focus. While shot technique is certainly important, shot technique is only useful if the target's depth and position is accurately and precisely identified. An athlete must identify the target without being distracted by surrounding stimuli, often within seconds or a fraction of a second. Further, for a shot to be accurate and precise, the margin for error may be inches or less than an inch. With the numerous distractions and competitions for focus and concentration involved in a typical athletic event, quickly identifying a target's depth and position with precision and accuracy can be very difficult.

There thus exists a need to aid an athlete in reaching a target by improving the athlete's chances of accurately, precisely and quickly identifying the depth and position of the target.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a system for use with a basketball rim is provided. The system includes a light assembly positioned proximal the basketball rim. The system has a tracking module for determining a shot position relative to the basketball rim and a control module in communication with the tracking module for illuminating a portion of the light assembly that faces the shot position.

According to one or more embodiments, the light assembly includes an outer facing array of lights that are outer facing relative to the rim.

According to one or more embodiments, the light assembly includes an inner facing array of lights that are inner facing relative to the rim.

According to one or more embodiments, the light assembly includes an array of discretely positioned lights.

According to one or more embodiments, the light assembly includes a continuous light that encircles at least a portion of the rim.

According to one or more embodiments, the light assembly is formed with the rim.

According to one or more embodiments, the light assembly is selectively engageable with the rim.

According to one or more embodiments, the light assembly includes an array of lights and one of the array of lights is carried by hooks for engaging with a net hanging from the rim.

According to one or more embodiments, the tracking module includes infrared sensors for sensing a position of a basketball or a position of a basketball shooter.

According to one or more embodiments, the tracking module includes an imaging device for sensing a position of a basketball or a position of a basketball shooter.

According to one or more embodiments, the tracking module is in communication with sensors positioned on a court proximal the basketball rim for sensing a position of a basketball or a position of a basketball shooter.

According to one or more embodiments, the tracking module is in communication with sensors positioned in the basketball for sensing a position of a basketball.

According to one or more embodiments, the tracking module is in communication with sensors carried by players playing with the basketball for sensing a position of a basketball shooter.

According to one or more embodiments, the control module directs an outer array of lights to illuminate at a first characteristic and direct an inner array of lights to illuminate at a second characteristic.

According to one or more embodiments, the first characteristic is a light intensity brighter than the second characteristic.

According to one or more embodiments, the first characteristic is a color different than a color of the second characteristic.

According to one or more embodiments, the system further includes a backboard lighting assembly in communication with a control module, the control module directing the backboard lighting assembly to illuminate a portion of a backboard for aiding in shot training of a basketball shooter.

According to one or more embodiments, a method is provided. The method includes providing a light assembly positioned proximal a basketball rim, a tracking module determining a shot position relative to the basketball rim, and a control module communicating with the tracking module and illuminating a portion of the light assembly that faces the shot position.

According to one or more embodiments, the shot position is determined using a position of a basketball or a position of a basketball shooter.

According to one or more embodiments, illuminating a portion of the light assembly includes directing an outer array of lights to illuminate at a first characteristic and directing an inner array of lights to illuminate at a second characteristic.

According to one or more embodiments, the method further includes the control module communicating with a backboard lighting assembly and directing the backboard lighting assembly to illuminate a portion of a backboard for aiding in shot training of a basketball shooter.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIGS. 1-3 are views of the system for use with the basketball rim according to one or more embodiments disclosed herein.

FIG. 4 is a view of a tracking and a control module positioned within the system according to one or more embodiments disclosed herein.

FIG. 5 and FIGS. 6A and 6B are views of the system in use with the basketball rim according to one or more embodiments disclosed herein.

FIG. 7 is a view of the system in use with the backboard according to one or more embodiments disclosed herein.

FIG. 8 is an overhead view of a court having for use with the system disclosed herein.

FIGS. 9A through 9C illustrate a sequential view of a ball moving across a basketball court and a selected portion of the rim being illuminated in response thereto.

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

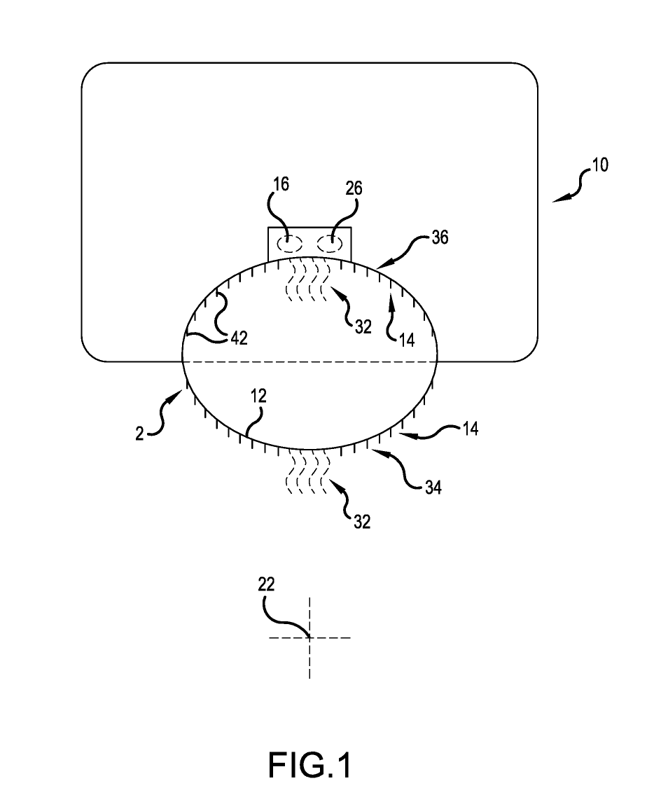

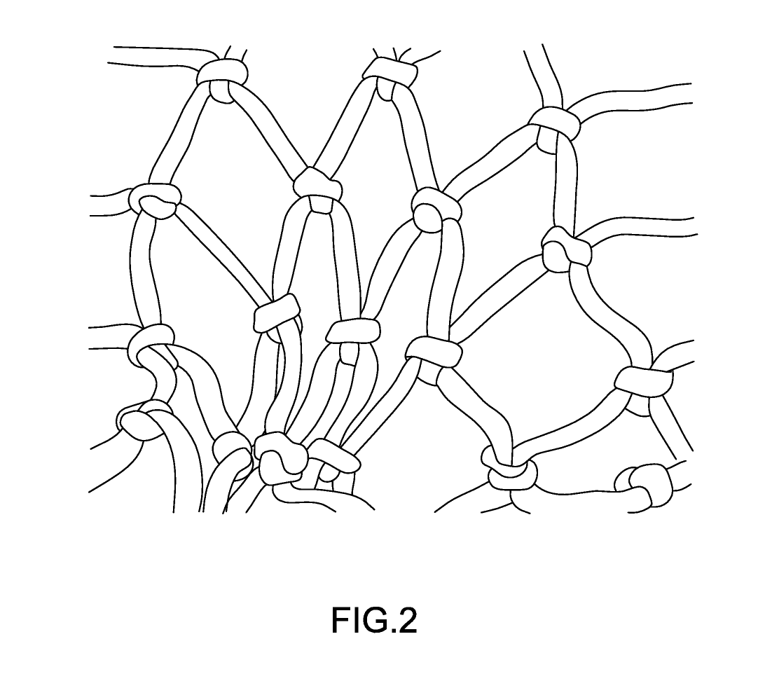

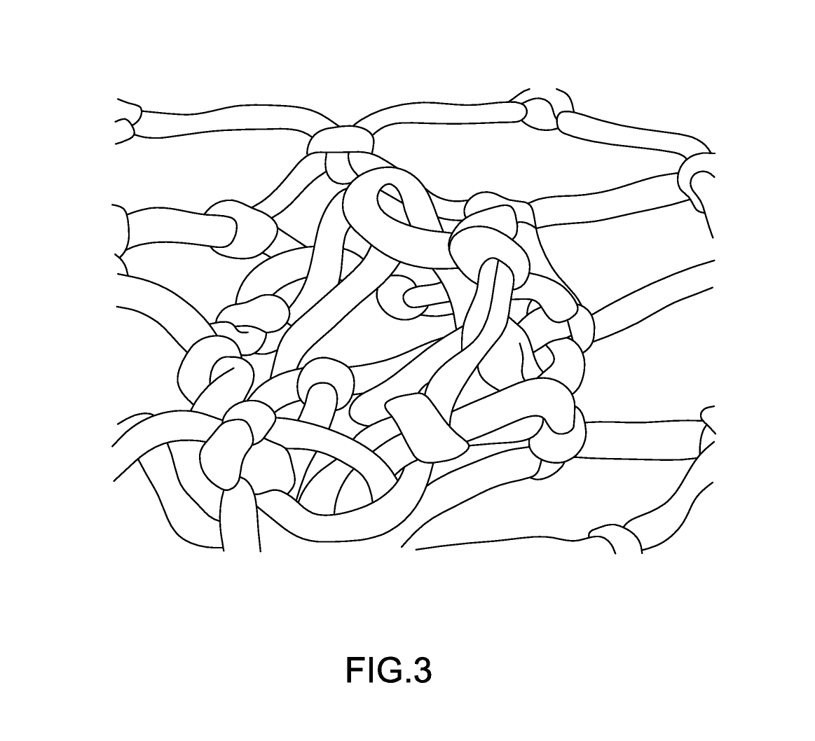

FIG. 1 depicts an embodiment of a system 10 for use with a basketball rim 12 for training a basketball shooter. The system includes a light assembly 14 positioned proximal to the basketball rim 12. In the embodiment depicted in FIG. 1, the light assembly 14 is formed with and inside the basketball rim 12 and includes both an outer facing array of lights 34 that are outer facing relative to the basketball rim 12 and an inner facing array of lights 36 that are inner facing relative to the basketball rim 12. Further, in the embodiment illustrated, both the inner facing array of lights 34 and the outer facing array of lights 36 include discretely positioned lights 42. Of the discretely positioned lights, a portion 32 of the light assembly that faces a shot position 22 is selectively illuminated. FIGS. 2 and 3 depict example prototypes of one or more embodiments of the system 10 disclosed herein.

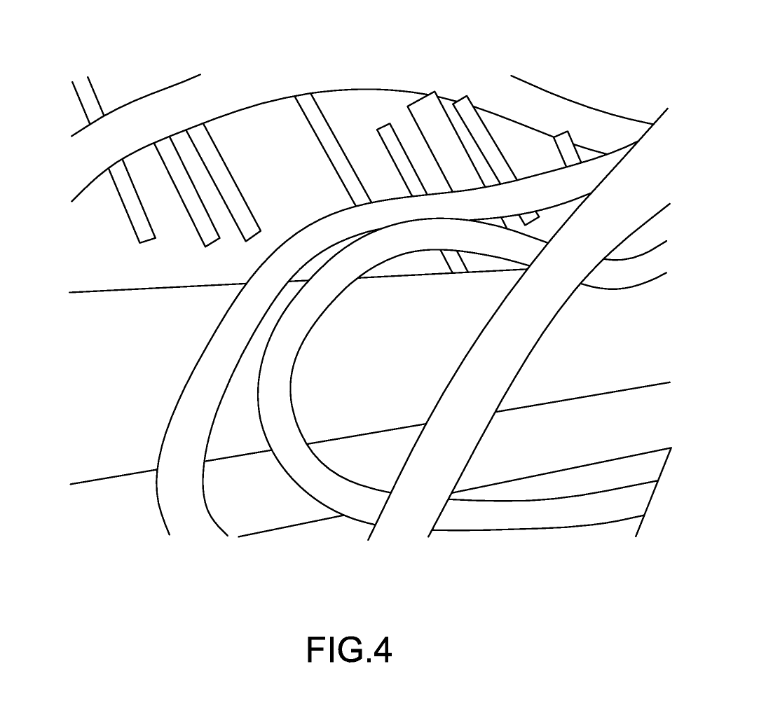

In alternative embodiments of the invention, the light assembly 14 may have different positions. In addition to being positioned within the basketball rim 12, as depicted in FIG. 1, the light assembly 14 may be positioned in any other position proximal to the basketball rim 12, including above, below, inside, outside and a combination of directions relative to and proximal the basketball rim 12. Further, the light assembly 14 may be formed with the basketball rim 12, as depicted in FIG. 1, or may formed separate from the basketball rim 12, as depicted in FIGS. 2 through 4. In embodiments where the light assembly 14 is formed separate from the basketball rim 12, the light assembly may be selectively engageable to the basketball rim 12, the backboard 76, the hooks 52 of the basketball rim 12, or any other structure located within the vicinity of the basketball rim 12. In this manner, discrete or continuous lights may be affixed to the hooks that hold the net and will not interfere with the rim operation.

In alternative embodiments of the invention, the light assembly 14 may have different configurations. In one embodiment, the light assembly 14 may include both an outer facing array of lights 34 that are outer facing relative to the basketball rim 12 and an inner facing array of lights 36 that are inner facing relative to the basketball rim 12, as depicted in FIG. 1. In alternative embodiments, the light assembly 14 may only include either the outer facing array of lights 34 or the inner facing array of lights 36. Further, the light assembly 14 may include one or multiple arrays of lights that each face in any number of directions or range of directions.

As depicted in FIG. 1, the light assembly 14 may include discretely positioned lights 42. Alternatively, the light assembly 14 may include a continuous light 44 that encircles at least a section 46 of the basketball rim 12. Further, the light assembly may include a combination of discretely positioned lights 42 and a continuous light 44 that encircles at least a section 46 of the basketball rim 12.

Additional alternative embodiments of the light assembly 14 position and configuration are discussed in the descriptions of FIGS. 2 through 2 through 4 and FIG. 6 infra.

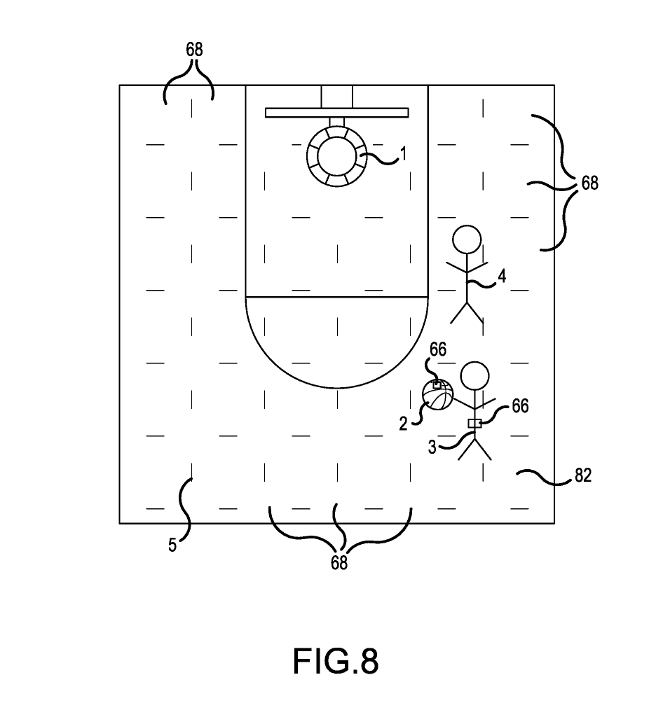

The system 10 of FIG. 1 may include a tracking module 16 configured for determining a shot position 22 relative to the basketball rim 12. The tracking module 16 may determine the shot position 22 using a number of different technologies and methods described herein. The tracking module 16 may be configured to communicate with infrared capable receiving sensors or sensors 66 for sensing a basketball position 24 and/or a shooter position 25 for determining the shot position 22 relative to the basketball rim 12. With further reference to FIG. 8, a sensor 66 is shown embedded or otherwise carried by a ball 2 or worn by a basketball player 3. The sensor 66 may be worn by a player's by being integrated into a player's clothing. Alternatively, the tracking module 16 may include an imaging device 62 for sensing a basketball position 24 and/or a shooter position 25 for determining the shot position 22. In this manner, the imaging device 62 may image the court to determine the position of the basketball. The tracking module 16 communicates with control module 26 that then directs either a portion of continuous light assembly 14 or a discrete light of the light assembly 14 that is facing the shooter to illuminate.

As illustrated in FIG. 8, in another embodiment, the tracking module 16 is in communication with a sensor or sensors 68 positioned on a court 5 proximal the basketball rim 12 for sensing the basketball position 24 and/or the shooter position 25 for determining the shot position 22. The sensors 68 are shown as gridded sections on the court 5. Further, the tracking module 16 may be in communication with a sensor or sensors 64 positioned in the basketball for sensing the basketball position for determining a shot position 22. Additionally, the tracking module 16 may be in communication with a sensor or sensors 64 carried by a basketball shooter 3 or players 4 playing with the basketball 2.

In any of the tracking module 16 embodiments described supra, the tracking module 16 may determine the shot position 22 using the sensed basketball position 24, shooter position 25, and/or the movement and position of players 4 in relation to the basketball rim 12. For example, the tracking module 16 may sense the basketball position 24 and determine the shot position 22 to be equal to the basketball position 24. Alternatively, the tracking module 16 may sense the basketball position 24 and determine the shot position 22 to be equal to the basketball position 24 only when the basketball position 24 is at least 4 feet above the court 5. In another example, the tracking module 16 may sense the shooter position 25 and determine the shot position 22 to be relative to the shooter position 25 based on previously received information, such as the basketball shooter 3 height, dominant shooter hand, shooting style, and build. In yet another embodiment, the tracking module 16 may sense the movement and position of players 5 and determine the shot position 22. The calculations and determinations of the tracking module 16 are not limited to the examples disclosed herein.

The system 10 of FIG. 1 additionally includes control module 26 in communication with the tracking module 16 and configured for illuminating a portion 32 of the light assembly 14 that faces the shot position 22 illustrated in the intersecting axis of FIG. 1. The control module 26 may illuminate a portion 32 of the light assembly 14 at various characteristics, including, but not limited to, light intensity, color, illumination pattern, illumination direction, or any combination thereof. In one embodiment, the control module 26 is configured to direct an outer array of lights 36 to illuminate at a first characteristic and direct an inner array of lights 34 to illuminate at a second characteristic. By illuminating the outer array of lights 34 and the inner array of lights 36 with differing characteristics, the system 10 provides the basketball shooter 3 with enhanced depth perception compared to a typical basketball rim. In one embodiment, the first characteristic is a light intensity brighter than the second characteristic. In another embodiment, the first characteristic is a color different than a color of the second characteristic. Control module 26 may include memory, a processor, RAM, and the like for directing the light assembly 14 to illuminate a respective portion facing the determined shot position 22.

In the embodiments depicted in FIGS. 2 through 4, the light assembly 14 is positioned enwrapping the basketball rim 12, the outer facing array of lights 34 are positioned parallel and outside of the basketball rim 12, and the inner facing array of lights 36 are positioned parallel and inside of the basketball rim 12. In these embodiments, the light assembly 14 is selectively engaged with the basketball rim 12.

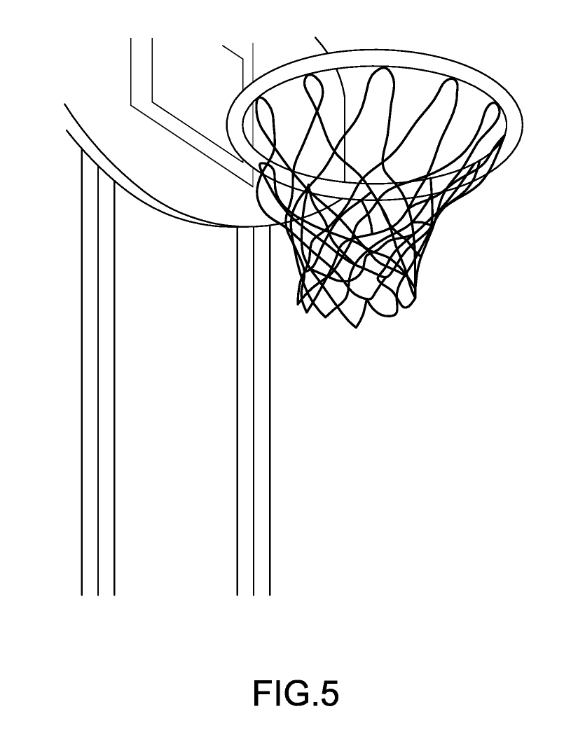

In the embodiment depicted in FIG. 5, the light assembly 14 is formed with and inside the basketball rim 12 and includes a continuous light 44 that encircles at least a portion 46 of the basketball rim 12.

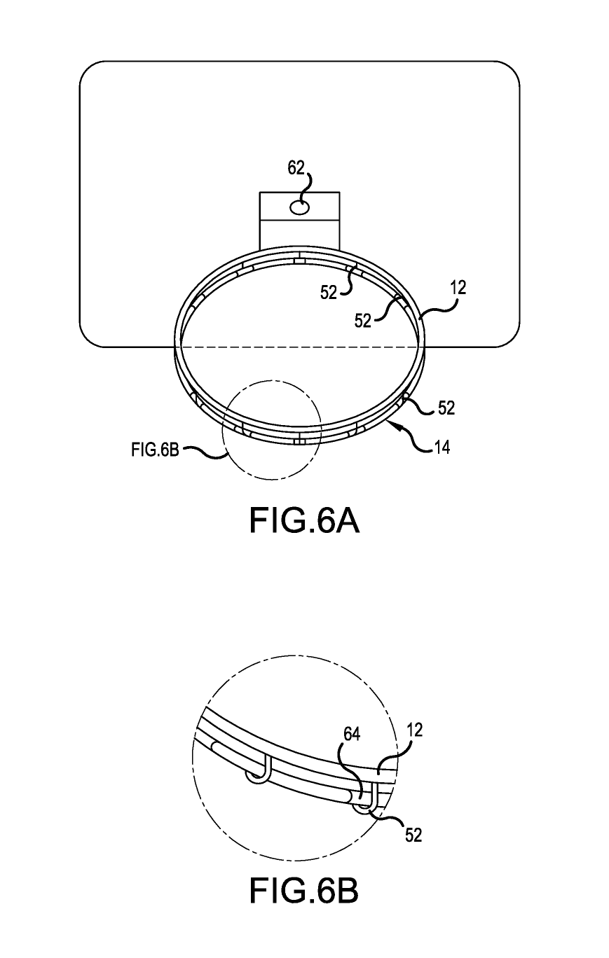

In the embodiment depicted in FIG. 6, the light assembly 14 is positioned beneath the basketball rim 12, the light assembly 14 including a respective one 64 of the array carried by hooks 52 configured for engaging with a net 1 hanging from the basketball rim 12.

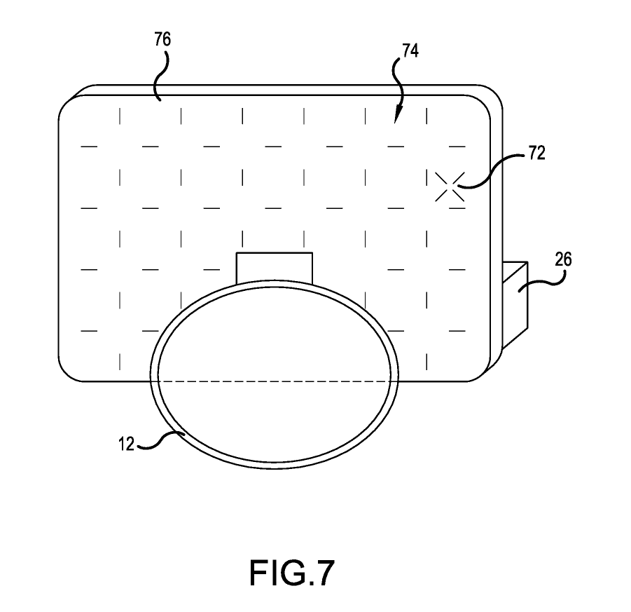

In the embodiment depicted in FIG. 7, the system 10 further includes a backboard lighting assembly 74 in communication with the control module 26. The control module 26 is configured to direct the backboard lighting assembly 74 to illuminate a portion 72 of the backboard 76 for aiding in shot training of a basketball shooter 3. For example, if the basketball shooter is practicing bank shots, where the basketball 2 is banked against the backboard 76 before attempting to travel through the basketball rim 12, the control module 26 may direct the backboard lighting assembly to illuminate a portion 72 of the backboard 76. In this example, the illuminated portion 72 aids the basketball shooter 3 by enhancing the shooter's ability to focus on the portion of the backboard that where placement of the basketball shot would most likely result in a basket being made.

In another embodiment, the control module 26 may additionally illuminate lights 82 positioned on the court 5. The illumination of the lights 82 positioned on the court 5 may form a straight line from the shot position 22 to the illuminated portion 32 of the light assembly 14.

In another embodiment, the basketball rim 12 is touch-sensitive. In such an embodiment, the touch-sensitive basketball rim 12 is monitored by a shot module, either local or remote. In one embodiment, the shot module may determine whether a shot was made by the basketball shooter 3 and/or how far and in which direction a shot was missed, if the shot resulted in the basketball 2 touched the basketball rim 12. In another embodiment, the tracking module 16 may determine whether a shot was made and/or how far and in which direction a shot was missed, whether the shot resulted in the basketball 2 touching the basketball rim 12 or not. In yet another embodiment, the tracking module 16 may communicate with the shot module to make the determinations discussed supra. The shot module and/or the tracking module 16 may aggregate the determinations into a printable format, available to print at a local or remote printer.

In one embodiment, the method of using the system involves tracking module 16 determining a shot position 22 relative to the basketball rim 12 and a control module 26 communicating with the tracking module 16 and illuminating a portion 32 of the light assembly 14 that faces the shot position 22. By illuminating the portion 32 of the light assembly 14 that faces the shot position 22, the focus and concentration of the basketball shooter 3 on the precise and accurate target is enhanced. Without the illumination, the basketball shooter 3 is required to determine the target location while attempting to make the shot, which often occurs within seconds or fractions of a second. As is apparent, not every shot directed at a basketball rim 12 will be made. Due to the outer circumference of the basketball 2 and the inner circumference of the basketball rim 12, there is little room for error. By illuminating the precise location where the shot is most likely to succeed, the system enhances the basketball shooter's ability to quickly and accurately concentrate on the target.

In another embodiment, the illumination of light assembly 14 includes directing an outer array of lights 34 to illuminate at a first characteristic and directing an inner array of lights 36 to illuminate at a second characteristic. For example, the outer array of lights 34 be illuminated at a first characteristics of being a brighter intensity or differing color than the second characteristic of the inner array of lights 36. This contrast between the first and second characteristics further enhances the basketball shooter's perception of the target by providing a greater contrast in depth.

The depth perception of the basketball shooter 3 may be further enhanced by altering the characteristics of the illuminated portion 32 of the light assembly 14 relative to the shot position 22. For example, as the shot position 22 moves further from the basketball rim 12, the brightness of the illuminated portion 32 may be increased, signifying to the basketball shooter 3 that greater force is need for the basketball 2 to reach the basketball rim 12.

In another embodiment, the control module 26 may communicate with a backboard lighting assembly 74 and direct the backboard lighting assembly 74 to illuminate a portion 72 of a backboard 76 for aiding in shot training of a basketball shooter 3. In one embodiment, the illumination of the portion 72 of the backboard 76 may be performed in combination with the illumination of the portion 32 of the light assembly 14. In another embodiment, the illumination of the portion 72 of the backboard 76 may be performed without illuminating the portion 32 of the light assembly 14.

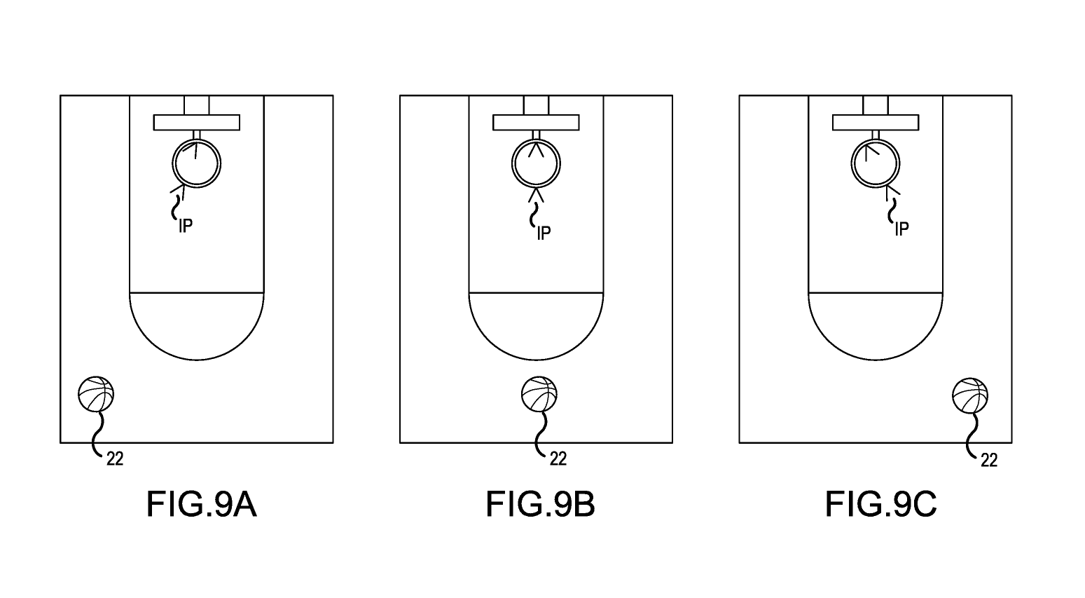

FIGS. 9A, 9B, and 9C illustrate an overhead view of system 10 in operation. As shown in the sequential views of FIG. 9A, 9B, and 9C, the ball 22 moves from left to right. The portion of the rim 12 that is illuminate is represented as illuminated portion “IP” and moves from left to right as the ball 22 moves from left to right. The position of ball 22 is determined by the tracking module disclosed herein.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

### CONCLUSION

While various preferred embodiments have been shown and described, modifications thereof can be made by one skilled in the art without departing from the spirit and teachings herein. The embodiments herein are exemplary only, and are not limiting. Many variations and modifications of the apparatus disclosed herein are possible and within the scope of the invention. Accordingly, the scope of protection is not limited by the description set out above.

What is claimed is:

1. A system for use with a basketball rim, comprising;
a light assembly; and
one or more clips adapted for securing the light assembly to a basketball rim.

2. The system of claim 1, further comprising a reflective member adapted for covering a front surface of a backboard.

3. The system of claim 1, further comprising a tracking module configured for determining a shot position relative to the basketball rim.

4. The system of claim 1, further comprising a control module in communication with the tracking module and configured for illuminating a portion of the light assembly that faces the shot position.

5. The system of claim 1, wherein the light assembly includes an outer facing array of lights that are outer facing relative to the rim.

6. The system of claim 1, wherein the light assembly includes an inner facing array of lights that are inner facing relative to the rim.

7. The system of claim 1, wherein the light assembly is detachably connected to the rim.

8. The system of claim 3, wherein the tracking module includes infrared sensors for sensing a basketball position or a shooter position relative to the basketball rim.

9. The system of claim 3, wherein the tracking module includes an imaging device for sensing a basketball position or a shooter position relative to the basketball rim.

10. The system of claim 4, wherein the control module is configured to direct an outer array of lights to illuminate at a first characteristic and direct an inner array of lights to illuminate at a second characteristic.

11. A system for use with a basketball rim, comprising;
a light assembly;
one or more clips adapted for securing the light assembly to a basketball rim;
a reflective member adapted for covering a front surface of a backboard;
a tracking module configured for determining a shot position relative to the basketball rim; and
a control module in communication with the tracking module and configured for illuminating a portion of the light assembly that faces the shot position.

12. The system of claim 11, wherein the light assembly includes an outer facing array of lights that are outer facing relative to the rim.

13. The system of claim 11, wherein the light assembly includes an inner facing array of lights that are inner facing relative to the rim.

14. The system of claim 11, wherein the light assembly is detachably connected to the rim.

15. The system of claim 11, wherein the tracking module includes infrared sensors for sensing a basketball position or a shooter position relative to the basketball rim.

16. The system of claim 11, wherein the tracking module includes an imaging device for sensing a basketball position or a shooter position relative to the basketball rim.

17. The system of claim 11, wherein the control module is configured to direct an outer array of lights to illuminate at a first characteristic and direct an inner array of lights to illuminate at a second characteristic.

18. A method for practicing shooting a basketball, comprising:
providing a light assembly positioned proximal a basketball rim; and
illuminating a portion of the light assembly over which a shooter is to try to shoot the basketball.

19. The method of claim 18, further comprising providing a reflective member adapted for covering a front surface of a backboard.

20. The method of claim 18, wherein illuminating a portion of the light assembly includes directing an outer array of lights to illuminate at a first characteristic and directing an inner array of lights to illuminate at a second characteristic.
